(19) United States
(12) Patent Application Publication
(10) Pub. No.: US 2014/0352289 A1
(43) Pub. Date: Dec. 4, 2014

(54) POSITION ADJUSTMENT AND POSITION LOCKING OF A FLUID OPERATED ACTUATOR

(71) Applicant: Norgen GmbH, Alpen (DE)

(72) Inventors: Ralph Riedel, Rheinberg (DE); Wolfgang van den Berg, Rheinberg (DE); Hans-Peter Kuhlmann, Xanten (DE)

(21) Appl. No.: 14/368,165

(22) PCT Filed: Jan. 10, 2013
(86) PCT No.: PCT/EP2013/050386

§ 371 Date: Jun. 23, 2014

Related U.S. Application Data
(60) Provisional application No. 61/586,240, filed on Jan. 13, 2012.

(51) Int. Cl. F15B 15/26

(52) U.S. Cl. CPC F15B 15/261
USPC 60/327; 92/23

(57) ABSTRACT

A fluid operated actuator (103) is provided that includes an actuator housing (104) and a piston assembly (109) including a piston (106) and a piston rod (108) movable within the actuator housing (104). The fluid operated actuator (103) further includes a plurality of detents (210) unified with the piston rod (108) and a lock (209) configured to move between a first and a second position. The lock engages the plurality of detents (210) when the lock (209) is in the first position or the second position to prevent the piston assembly (109) from moving with respect to the actuator housing (104). The lock further disengages from the plurality of detents (210) when the lock (209) is between the first and second positions to allow the piston assembly (109) to move with respect to the actuator housing (104).

### TECHNICAL FIELD The embodiments described below relate to, fluid operated actuators, and more particularly, to a fluid operated actuator with improved position adjustment and position locking.

### BACKGROUND OF THE INVENTION

Fluid operated actuators are used in a wide variety of industries and have received great commercial success. Generally, fluid operated actuators either convert a fluid pressure into mechanical motion or convert a mechanical motion into a change in fluid pressure. The fluid used with the fluid operated actuator generally comprises air, such as in pneumatic actuators or hydraulic fluid, for example. Both types of fluid have advantages and in some situations either type of fluid may be used. Generally, pneumatic actuators are utilized where a high speed operation is required. Conversely, hydraulic fluid is often a good choice when a higher fluid pressure and thus, higher force is required.

One exemplary use of fluid operated actuators is in the drinks industry. Typically during the bottling and processing process, bottles of various sizes are transferred between several locations on a conveyor system. The bottles are kept upright and/or on a conveyor belt using rails. The distance between the rails may need to change based on the particular size bottle being transported. In many circumstances, the distance between the rails is controlled manually. Some newer systems utilize a plurality of fluid operated actuators for controlling the distance. As can be appreciated, when the distance between the rails is controlled manually, changing the distance becomes a time consuming and costly process. While the use of fluid operated actuators can increase the speed of adjusting the rail-to-rail distance, prior art approaches to using fluid operated actuators has been inadequate. The fluid operated actuators either require a constant monitoring and control of fluid pressure, which is undesirable considering the long periods of time between changing the distance between the rails, or a manual lock is required, which generally requires a worker to physically put the lock in place. Even in some automated locking systems, a worker is still required to inspect all of the actuators to ensure they are in the correct position before being locked into place.

There exists a need for a fluid operated actuator that can be actuated to a desired position and maintained in that position without a continuous supply of power or fluid pressure. Further, there exists a need for a system that can accurately position the fluid operated actuator without requiring a worker to physically inspect the position of the fluid operated actuator's piston assembly.

The embodiments described below overcome these and other problems and an advance in the art is achieved. The embodiments described below provide a fluid operated actuator, which can be accurately positioned using a mechanical lock that interacts with detents provided on or coupled to a piston assembly. The mechanical lock may be moved into and out of position using a second fluid operated actuator or some other type of actuation system. Upon the mechanical lock reaching one or more predetermined positions, the piston assembly of the main fluid operated actuator can no longer move and is thus, locked into position.

### SUMMARY OF THE INVENTION

A fluid operated actuator is provided according to an embodiment. The fluid operated actuator comprises an actuator housing and a piston assembly including a piston and a piston rod movable within the actuator housing. According to an embodiment, the fluid operated actuator further comprises a plurality of detents unified with the piston rod and a lock configured to move between a first and a second position. According to an embodiment, the lock engages the plurality of detents when the lock is in the first position or the second position to prevent the piston assembly from moving with respect to the actuator housing. The lock further disengages from the plurality of detents when the lock is between the first and second positions to allow the piston assembly to move with respect to the actuator housing.

A method for controlling a position of a piston assembly including a piston and a piston rod of a fluid operated actuator is provided according to an embodiment. According to an embodiment, the method comprises a step of locking the piston assembly using a lock movable between a first position and a second position that engages a plurality of detents unified with the piston rod at the first and second positions. According to an embodiment, the method further comprises steps of biasing the piston assembly in a first direction and actuating the lock from the first position towards the second position. According to an embodiment, the method further comprises a step of disengaging the lock from the plurality of detents when the lock is between the first and second positions to allow the piston assembly to move a predetermined distance in the first direction before engaging the lock with the plurality of detents when the lock reaches the second position.

### ASPECTS

According to an aspect, a fluid operated actuator comprises:
an actuator housing;
a piston assembly including a piston and a piston rod movable within the actuator housing;
a plurality of detents unified with the piston rod; and
a lock configured to move between a first and a second position to:
   engage the plurality of detents when the lock is in the first position or the second position to prevent the piston assembly from moving with respect to the actuator housing; and
   disengage from the plurality of detents when the lock is between the first and second positions to allow the piston assembly to move with respect to the actuator housing.

Preferably, the plurality of detents are unified with the piston rod by being formed as part of the piston rod.

Preferably, the plurality of detents are unified with the piston rod by being coupled to the piston rod.

Preferably, the fluid operated actuator further comprises a lock housing coupled to the actuator housing and enclosing at least a portion of the lock.

Preferably, the fluid operated actuator further comprises a biasing member located within the lock housing and biasing the lock in a first direction.

Preferably, the fluid operated actuator further comprises an actuation chamber and a fluid port, wherein pressure in the actuation chamber biases the lock in a second direction.

Preferably, the plurality of detents comprise upper detents and lower detents, which are offset from the upper detents by a predetermined distance.

Preferably, the lock comprises an upper catch configured to engage upper detents of the plurality of detents and a lower catch configured to engage lower detents of the plurality of detents.

Preferably, the upper catch is offset from the lower catch by a predetermined distance.

According to another aspect, a method for controlling a position of a piston assembly including a piston and a piston rod of a fluid operated actuator comprises steps of:
locking the piston assembly using a lock movable between a first position and a second position that engages a plurality of detents unified with the piston rod at the first and second positions;
biasing the piston assembly in a first direction; actuating the lock from the first position towards the second position; and
disengaging the lock from the plurality of detents when the lock is between the first and second positions to allow the piston assembly to move a predetermined distance in the first direction before engaging the lock with the plurality of detents when the lock reaches the second position.

Preferably, the step of biasing the piston assembly comprises pressurizing a first fluid chamber of the fluid operated actuator.

Preferably, the step of actuating the lock comprises pressurizing an actuation chamber defined by the lock and a lock housing that encloses at least a portion of the lock.

Preferably, the plurality of detents comprise upper detents and lower detents, which are offset from the upper detents by a predetermined distance, d.

Preferably, the step of locking the piston assembly comprises engaging an upper catch of the lock with upper detents of the plurality of detents.

Preferably, the step of engaging the lock with the plurality of detents when the lock reaches the second position comprises engaging a lower catch of the lock with lower detents of the plurality of detents.

### BRIEF DESCRIPTION OF THE DRAWINGS

FIG. 1 shows a portion of a conveyor system according to an embodiment.

FIG. 2 shows a cross-sectional view of a fluid operated actuator according to an embodiment.

FIG. 3 shows a cross-sectional view of a fluid operated actuator according to another embodiment.

### DETAILED DESCRIPTION OF THE INVENTION

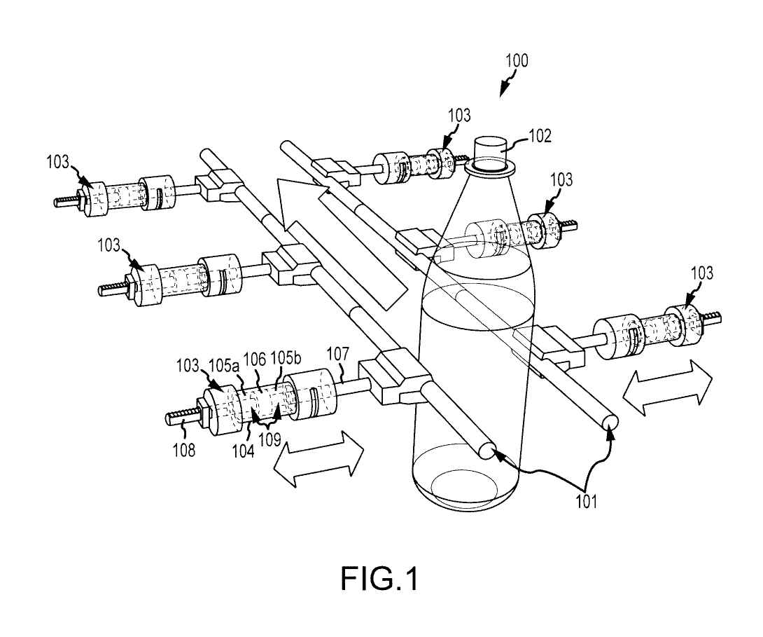

FIGS. 1-3 and the following description depict specific examples to teach those skilled in the art how to make and use the best mode of embodiments of a fluid operated actuator. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the fluid operated actuator. As a result, the embodiments described below are not limited to the specific examples described below, but only by the claims and their equivalents.

FIG. 1 shows a portion of a conveyor system 100 according to an embodiment. The conveyor system 100 comprises two or more rails 101 along with a conveying system (not shown) to move the bottles 102. The two rails 101 shown in FIG. 1 are positioned using a plurality of fluid operated actuators 103. It should be appreciated that the fluid operated actuators 103 could be used in a wide variety of applications and the conveyor system 100 is merely shown as one exemplary use of the fluid operated actuators 103 to aid the reader in appreciating the fluid operated actuators 103. Therefore, the claims directed towards the fluid operated actuators 103 should not require the remaining components of the conveyor system 100.

As shown in FIG. 1 and in greater detail in the subsequent figures, each fluid operated actuator 103 of the plurality of fluid operated actuators shown comprises a housing 104. Although not shown, in use, the housing 104 can be coupled to a stationary mount in order to maintain the positioning of the fluid operated actuator 103.

The housing 104 is shown as comprising an at least partially transparent material in order to show the interior components of the fluid operated actuator 103. It should be appreciated that in many embodiments, the housing 104 does not comprise a transparent material and the housing 104 is merely shown as being transparent to aid the reader in understanding the presently described embodiment.

According to an embodiment, the housing 104 is divided into two or more fluid chambers 105a, 105b by a piston 106. According to an embodiment, a first piston rod 107 is coupled to and extends from the piston 106 in a first direction and is subsequently coupled to a rail 101. Coupled to and extending from the piston 106 in a second direction is a second piston rod 108. The second piston rod 108 can be utilized to control the position of the piston 106 and thus, the first piston rod 107. According to an embodiment, the piston 106, the first piston rod 107, and the second piston rod 108 are coupled to one another to form a piston assembly 109. As can be appreciated, control of the piston assembly 109 can control the positioning of the rails 101 in order to accommodate various sizes of bottles traveling on the conveyor system 100.

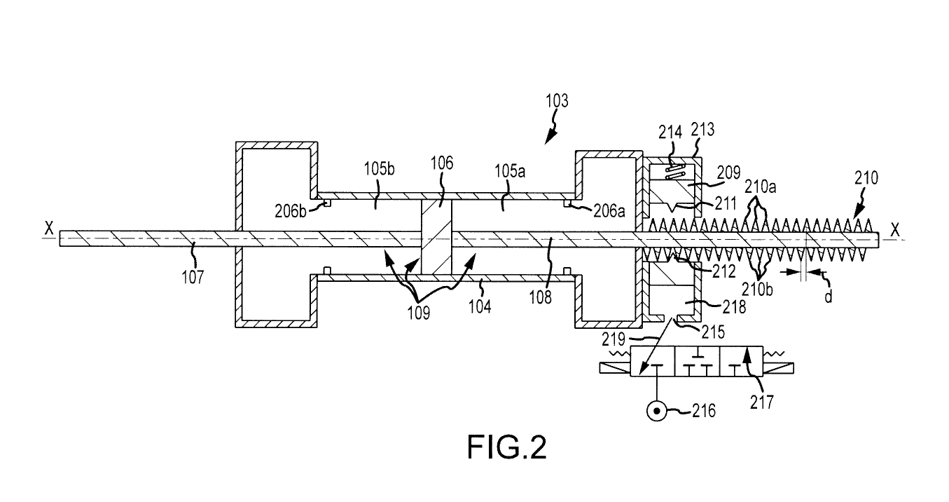

FIG. 2 shows a cross-sectional view of a fluid operated actuator 103 according to an embodiment. The two fluid chambers 105a, 105b are more visible in FIG. 2 and now it is clear that the piston 106 separates the housing 104 into the two fluid chambers 105a, 105b. Although not shown, the housing 104 also includes fluid ports in order to selectively supply and exhaust fluid to and from the fluid chambers 105a, 105b. The fluid may comprise air, hydraulic fluid, or some other type of suitable fluid. The particular fluid used should in no way limit the scope of the present embodiment.

Furthermore, as those skilled in the art will appreciate, the fluid operated actuator 103 will include the appropriate seals in order to maintain a fluid-tight seal between the piston 106 and the housing 104 as well between the piston rods 107, 108 and the housing 104. The seals are omitted from the drawings for simplicity.

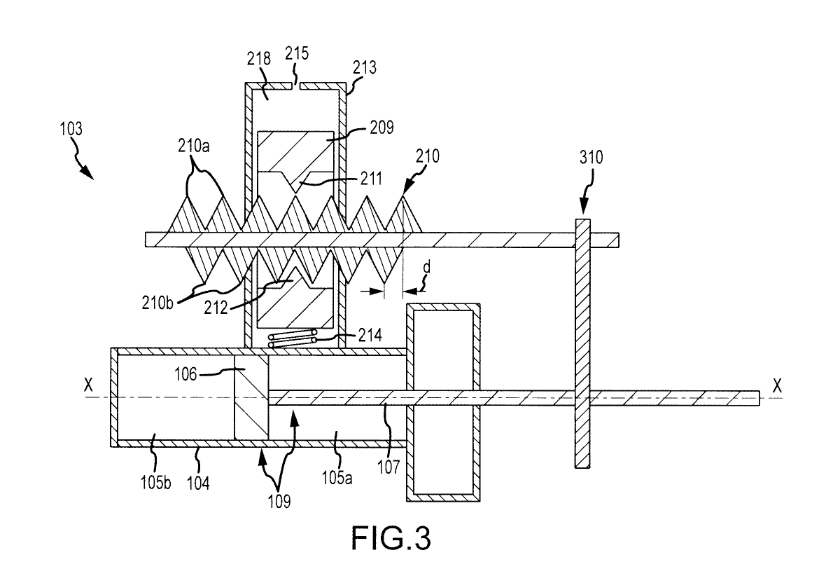

According to the embodiment shown in FIG. 2, the housing 104 also includes a plurality of stops 206a, 206b. The stops 206a, 206b can comprise projections extending from an interior of the housing 104 into the first and second fluid chambers 105a, 105b, that can allow passage of the piston rods 107, 108, respectively, but prevent passage of the piston 106. Therefore, the stops 206a, 206b can limit the travel distance of the piston 106 and thus, the entire piston assembly 109. It should be appreciated that not all embodiments require the stops 206a, 206b. Rather, in other embodiments, the travel distance of the piston 106 may be limited by the walls of the housing 104 itself, for example (see FIG. 3).

According to an embodiment, the fluid operated actuator 103 further comprises a lock 209. The lock 209 is sized and shaped to engage a plurality of detents 210 unified with the piston assembly 109. More specifically, according to the embodiment shown in

FIG. 2, the lock 209 is sized and shaped to selectively engage a plurality of detents 210 unified with the second piston rod 108. It should be appreciated that in the present application, the “detents” can comprise threads, grooves, protrusions, teeth, stubs, indents, etc. that engage upper and lower detent catches 211, 212 of the lock 209 and prevent movement of the piston assembly 109 with respect to the lock 209. Therefore, although the catches 211, 212 are shown as protrusions, in other embodiments, the catches 211, 212 may comprise grooves or depressions that can engage protrusions of the detents 210. Furthermore, while only a single upper catch 211 and a single lower catch 212 are shown, in other embodiments, more than one upper and/or lower catch may be provided.

According to an embodiment, the detents 210 may be unified with the piston assembly 109 by being formed as integral components of the piston assembly 109, or alternatively, the detents 210 may be unified with the piston assembly 109 by being coupled to the piston assembly 109 (See FIG. 3). The detents 210 may be removably coupled to the piston assembly 109 or substantially permanently coupled to the piston assembly 109. Furthermore, while the embodiments shown disclose the detents 210 being formed on or coupled to the second piston rod 108, in other embodiments, the detents 210 may be formed on or coupled to the first piston rod 107. In such embodiments, the second piston rod 108 may be omitted (See FIG. 3). Therefore, the description and claims should not be limited to the precise positioning of the detents 210 shown in the figures. However, it is important that movement of the detents 210 represent movement of the piston assembly 109.

According to an embodiment, the upper catch 211 of the lock 209 engages the upper detents 210a of the piston assembly 109 when the lock 209 is in a first position. According to an embodiment, the lower catch 212 engages the lower detents 210b when the lock 209 is in a second position. The lock 209 is in the second position in FIG. 2. According to an embodiment, neither the upper catch 211 nor the lower catch 212 engage the detents 210 when the lock 209 is in a third position. According to the embodiment shown, the third position is between the first and second positions. Therefore, when the lock 209 is in the third position, the piston assembly 109 is free to move with respect to the lock 209. Conversely, when the lock 209 is in either the first or the second position, the piston assembly 109 is locked into place with respect to the lock 209 due to the engagement of the detents 210 with the upper catch 211 or the lower catch 212.

According to an embodiment, the fluid operated actuator 103 can further include a lock housing 213. According to an embodiment, the lock housing 213 can be coupled to the actuator housing 104. However, in other embodiments, the lock housing 213 may be coupled to an external component that remains substantially stationary with respect to the actuator housing 104. The lock housing 213 can enclose at least a portion of the lock 209 and prevent the lock 209 from moving in a direction parallel to the longitudinal axis X-X of the actuator 103 and thus, the movement of the piston assembly 109. For example, in FIG. 2, the piston assembly 109 can move left and right, but it is substantially prevented from moving up and down due to the fluid-tight seal between the piston 106 and the housing 104. Therefore, the lock housing 213 substantially prevents the lock 209 from moving left and right, but allows the lock 209 to move up and down as shown in the figures. It should be appreciated that the particular directions used are in relation to the configuration of the drawings and should in no way limit the scope of the present embodiment.

According to an embodiment, the lock housing 213 can include a biasing member 214. The biasing member 214 can bias the lock 209 in a first direction. In the embodiment shown, the biasing member 214 biases the lock 209 down towards the first position. However, in other embodiments, the biasing member 214 may bias the lock up towards the second position, for example. In other embodiments, the biasing member 214 may be omitted and the weight of the lock 209 may be sufficient to bias the lock down towards the first position so long as the fluid operated actuator 103 is maintained in the proper orientation. In yet another embodiment, the biasing member 214 may be omitted and fluid pressure may be supplied to bias the lock 209 towards the first position.

The lock housing 213 further includes a fluid port 215. The fluid port 215 can be in fluid communication with a pressure supply 216 or an exhaust via a valve 217 and fluid line 219. In the embodiment shown, the valve 217 comprises a 3/3-way valve. The 3/3-way valve shown is spring biased to a center position where all of the ports are closed off However, in other embodiments, the valve 217 can comprise a 3/2-way valve, for example. The particular type of valve used should in no way limit the scope of the description and claims. According to an embodiment, the valve 217 can be actuated to selectively provide fluid to and exhaust fluid from an actuation chamber 218 in the lock housing 213. Fluid within the actuation chamber 218 can act on the lock 209 to bias the lock 209 in a direction opposite the direction the biasing member 214 acts on the lock 209. Consequently, it should be appreciated that a sealing member (not shown) can be provided to form a substantially fluid-tight seal between the lock 209 and the lock housing 213. Therefore, once the pressure within the actuation chamber 218 provides a force on the lock 209 that exceeds the force of the biasing member 214 along with any friction, the lock 209 can move from the first position to the second position.

It should be appreciated that while the lock 209 moves from the first position to the second position, the lock 209 passes through the third position. Once the lock reaches the third position, the upper and lower detents 210a, 210b are disengaged from the upper and lower catches 211, 212 of the lock 209. Even a brief time at the third position allows the piston assembly 109 to move as long as the piston assembly 109 is biased in one direction or the other. For example, even if the piston assembly 109 is biased to the left by a higher pressure in the first fluid chamber 105a than in the second fluid chamber 105b and the lower catch 212 is engaged with the lower detents 210b, the piston assembly 109 cannot move. However, if the pressure within the actuation chamber 218 is exhausted to a pressure that the biasing member 214 can overcome, the biasing member 214 can move the lock 209 down from the second position back towards the first position. As the lock 209 moves down, the lower catch 212 disengages from the lower detents 210a and the piston assembly 109 can move to the left. According to an embodiment, the upper and lower detents 210a, 210b are offset from one another along the longitudinal axis X-X by a distance, d. The distance, d can be predetermined, such that a user easily knows or can determine the distance, d. As shown, this creates a staggered configuration between the upper and lower detents 210a, 210b. It should be appreciated that as an alternative to offsetting the upper and lower detents 210a, 210b from one another, in other embodiments, the upper and lower catches 211, 212 could be offset from one another along the longitudinal axis X-X by the distance, d to create the staggered configuration.

The staggered configuration allows the piston assembly 109 to move over by the distance, d at a time as the lock 209 moves between the first and second position. For example, if the actuation chamber 218 is exhausted, the biasing member 214 can move the lock 209 down and the piston assembly 109 moves to the left. However, the lock 209 can be sized such that as the lower catch 212 is disengaging from the lower detents 210b, the upper catch 211 begins to engage the next set of upper detents 210a.

However, because the upper and lower detents 210a, 210b are offset from one another by a distance, d, the piston assembly 109 moves to the left by a distance, d. As can be appreciated, if pressure is subsequently supplied to the actuation chamber 218, the lock 209 can once again be moved back to the second position, i.e., up. As the lock 209 moves up towards the second position, it once again passes through the third position where the upper catch 211 disengages from the upper detents 210a and the lower catch 212 begins to engage the next set of lower detents 210b. This unique configuration allows for precise control of the position of the piston assembly 109. As can be appreciated, each time the lock 209 moves between the first and the second position, the piston assembly 109 can move by the predetermined distance, d. Therefore, if the piston assembly 109 is biased in one direction or the other, the lock 209 can act to control both the movement of the piston assembly 109 as well as lock the piston assembly 109 in a desired position.

It should be appreciated that while the description above explains the movement of the piston 106 to the left due to a higher pressure in the first fluid chamber 105a than in the second fluid chamber 105b, a similar movement can just as easily be realized in the opposite direction by providing the second fluid chamber 105b with a higher fluid pressure than the first fluid chamber 105a. Therefore, those skilled in the art should readily appreciate that the lock 209 can be capable of operating in both directions.

According to an embodiment, precise positioning of the piston assembly 109 can be achieved by the fluid operated actuator 103 using the lock 209 in combination with the detents 210. The example provided below is directed towards a situation when the fluid operated actuator 103 is utilized in the conveyor system 100 to control the positioning of the rails 101. However, those skilled in the art can easily appreciate how to incorporate the precise positioning in other situations.

According to an embodiment, if the positioning of the rails 101 needs to be adjusted, the piston assemblies of each of the plurality of fluid operated actuators 103 can be adjusted and held in a desired position using the lock 209. According to an embodiment, the piston assembly 109 can initially be positioned in a first position. According to one embodiment, the first position may be determined by the stop 206a, for example. According to yet another embodiment, the first position may be determined by the location of the first detent 210. Once the piston assembly 109 is in the first position, the desired position of the rail 101 with respect to the position of the rail 101 when the piston assembly 109 is in the first position can be determined. In one example, when the piston assembly 109 is in the first position, the rail 101 is in an outermost position, i.e., the distance between the rails 101 is at a maximum. This would be the case if the first position was with the piston 106 abutting the stop 206a, or alternatively, the lower catch 212 was engaged with the left most lower detent 210b shown in FIG. 2.

From the first end position, a user or operator can determine how far the rails need to be moved inwards for a particular sized bottle 102. Precise positioning can be ensured because the distance, d between succeeding upper and lower detents 110 is known. Therefore, as long as the piston assembly 109 is biased to the left, such as by providing the first fluid chamber 105a at a pressure higher than the second fluid chamber 105b, then each time the lock 209 is actuated from the second position to the first position, the piston assembly 109 moves to the left by the predetermined distance, d. Likewise, when pressure is once again supplied to the actuation chamber 218 to actuate the lock 209 from the first position back to the second position, the piston assembly 109 moves to the left by another distance, d. Therefore, the total distance a user desires to move the piston assembly 109 can easily be controlled by pressurizing and exhausting the actuation chamber 218 a desired number of times while maintaining the first fluid chamber 105a at a higher pressure than the second fluid chamber 105b. If the valve 217 is electrically actuated, a suitable processing system (not shown) can be in electrical communication with the valve 217 to easily control the number of times fluid is supplied to and exhausted from the actuation chamber 218.

Upon reaching the desired location, the first and second fluid chambers 105a, 105b can be exhausted if desired as the lock 209 can prevent any further movement of the piston assembly 109. According to the embodiment shown, the lock 209 can be maintained in either the first or second position by simply removing power from the valve 217 to allow the valve 217 to return to the middle position where the actuation chamber 218 is shut off from either exhausting or pressurizing. Therefore, with a 3/3-way valve, no additional energy is required to maintain the lock 209 in a locked and thus, engaged, position.

If on the other hand, the valve 217 comprises a 3/2-way valve, and the desired position occurs when the lock 209 is in the first position, then no pressure is required to maintain the desired position. Conversely, if the desired position occurs when the lock 209 is in the second position, then pressure can simply be maintained in the actuation chamber 218. Furthermore, the precise positioning of the rails 101 can be controlled electronically rather than requiring a worker to physically move, lock, or confirm the position of the rails 101. This obviously creates a faster and more efficient method for controlling the positioning of the rails compared to the prior art approaches.

FIG. 3 shows a cross-sectional view of a fluid operated actuator 103 according to another embodiment. While the embodiment shown in FIG. 2 shows the detents 210 unified with the piston assembly 109 by being formed on the second piston rod 108, in the embodiment shown in FIG. 3, the detents 210 are coupled to the piston assembly 109 via a bracket 310. The bracket 310 may be coupled to the piston assembly 109 using mechanical fasteners, brazing, welding, adhesives, etc. The particular method used to couple the bracket 310 to the piston assembly 109 is not important for purposes of the present embodiment. The bracket 310 can be useful in situations where space in the longitudinal direction of the fluid operated actuator 103 is limited. As can be seen, the bracket 310 repositions the detents 210 above the housing 104. Likewise, the lock housing 213 is coupled to the top of the actuator housing 104 rather than the side as in FIG. 2.

Another difference between the embodiment shown in FIG. 2 and the embodiment shown in FIG. 3 is that the second piston rod 108 has been removed. In the embodiment shown in FIG. 3, only a single piston rod 107 is provided. Consequently, the piston assembly 109 comprises the piston 106 and the piston rod 107. Removing the second piston rod 108 can further reduce the length of the fluid operated actuator 103 along the longitudinal axis X-X.

Additionally, in the embodiment shown in FIG. 3, the stops 206a, 206b have been omitted. Rather than using the stops 206a, 206b, movement of the piston assembly 109 is limited by the walls of the housing 104.

Despite the above-mentioned changes to the embodiment shown in FIG. 3, operation can be conducted in a substantially similar manner as described for FIG. 2.

It should be appreciated that while actuation of the lock 209 has been described using a biasing member 214 and fluid pressure, other methods for controlling the position of the lock 209 can be utilized. For example, a mechanical device can act on the lock 209. Alternatively, the lock 209 can be controlled via a solenoid. As another example, a shape memory alloy may be used to change the position of the lock. Those skilled in the art will readily appreciate that various methods can be used to actuate the lock 209 between the first and second positions. The particular method used should in no way limit the scope of the description and claims as the examples provided are merely to aid a reader in appreciating various alternatives. However, whatever method is used should be able to precisely keep track of the number of times the lock 209 is actuated between the first and second position to accurately control the position of the piston assembly 109.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other fluid operated actuators, and not just to the embodiments described above and shown in the accompanying figures. Accordingly, the scope of the embodiments described above should be determined from the following claims.

We claim:

1. A fluid operated actuator (103), comprising:
an actuator housing (104);
a piston assembly (109) including a piston (106) and a piston rod (108) movable within the actuator housing (104);
a plurality of detents (210) unified with the piston rod (108); and
a lock (209) configured to move between a first and a second position to:
engage the plurality of detents (210) when the lock (209) is in the first position or the second position to prevent the piston assembly (109) from moving with respect to the actuator housing (104); and
disengage from the plurality of detents (210) when the lock (209) is between the first and second positions to allow the piston assembly (109) to move with respect to the actuator housing (104).

2. The fluid operated actuator (103) of claim 1, wherein the plurality of detents (210) are unified with the piston rod (108) by being formed as part of the piston rod (108).

3. The fluid operated actuator (103) of claim 1, wherein the plurality of detents (210) are unified with the piston rod (108) by being coupled to the piston rod (108).

4. The fluid operated actuator (103) of claim 1, further comprising a lock housing (213) coupled to the actuator housing (104) and enclosing at least a portion of the lock (209).

5. The fluid operated actuator (103) of claim 4, further comprising a biasing member (214) located within the lock housing (213) and biasing the lock (209) in a first direction.

6. The fluid operated actuator (103) of claim 4, further comprising an actuation chamber (218) and a fluid port (215), wherein pressure in the actuation chamber (218) biases the lock (209) in a second direction.

7. The fluid operated actuator (103) of claim 1, wherein the plurality of detents (210) comprise upper detents (210a) and lower detents (210b), which are offset from the upper detents (210a) by a predetermined distance (d).

8. The fluid operated actuator (103) of claim 1, wherein the lock (209) comprises an upper catch (211) configured to engage upper detents (210a) of the plurality of detents (210) and a lower catch (212) configured to engage lower detents (210b) of the plurality of detents (210).

9. The fluid operated actuator (103) of claim 8, wherein the upper catch (211) is offset from the lower catch (212) by a predetermined distance (d).

10. A method for controlling a position of a piston assembly including a piston and a piston rod of a fluid operated actuator, comprising steps of:
locking the piston assembly using a lock movable between a first position and a second position that engages a plurality of detents unified with the piston rod at the first and second positions;
biasing the piston assembly in a first direction;
actuating the lock from the first position towards the second position; and
disengaging the lock from the plurality of detents when the lock is between the first and second positions to allow the piston assembly to move a predetermined distance in the first direction before engaging the lock with the plurality of detents when the lock reaches the second position.

11. The method of claim 10, wherein the step of biasing the piston assembly comprises pressurizing a first fluid chamber of the fluid operated actuator.

12. The method of claim 10, wherein the step of actuating the lock comprises pressurizing an actuation chamber defined by the lock and a lock housing that encloses at least a portion of the lock.

13. The method of claim 10, wherein the plurality of detents comprise upper detents and lower detents, which are offset from the upper detents by a predetermined distance, d.

14. The method of claim 10, wherein the step of locking the piston assembly comprises engaging an upper catch of the lock with upper detents of the plurality of detents.

15. The method of claim 10, wherein the step of engaging the lock with the plurality of detents when the lock reaches the second position comprises engaging a lower catch of the lock with lower detents of the plurality of detents.
